(19) United States
(12) Patent Application Publication
(10) Pub. No.: US 2020/0260889 A1
(43) Pub. Date: Aug. 20, 2020

(54) DEVICE FOR MAKING TEA WITH A TEABAG OR TEA INFUSER

(71) Applicant: Benjamin Forbes Pierce, San Francisco, CA (US)

(72) Inventor: Benjamin Forbes Pierce, San Francisco, CA (US)

(21) Appl. No.: 16/795,435

(22) Filed: Feb. 19, 2020

Related U.S. Application Data
(60) Provisional application No. 62/918,895, filed on Feb. 19, 2019.

(51) Int. Cl. A47G 19/16; A47J 31/44

(52) U.S. Cl. CPC A47G 19/16; A47J 31/4482

(57) ABSTRACT

A tea-making apparatus includes a stem member, a base, and a hanging device. The stem member includes a top end and a bottom end. The base may be attached to the bottom end of the stem member, wherein the base includes a drip pan. The base includes a portion of the base that may contact the tea steeping vessel while the tea-making apparatus may be suspended on the tea steeping vessel. The hanging device may be positioned at or attached adjacent to top end of the stem member. The hanging device may be adapted to suspend the tea-making apparatus from a rim of a tea steeping vessel.

### CROSS-REFERENCE TO RELATED APPLICATIONS

This application claims the benefit of U.S. provisional patent application Ser. No. 62/918,895, filed on Feb. 19, 2019, the contents of which are incorporated herein by reference in their entirety.

### BACKGROUND

When making tea, a stringed teabag, stringless teabag or tea infuser is placed in the hot water held in a tea steeping vessel, such as a cup. When the stringed teabag is placed in the empty tea steeping vessel and the tag and string associated with the stringed teabag are hung over the rim of the tea steeping vessel, the tag and string can be pulled into the tea steeping vessel when hot water is poured into the vessel. The tea-maker must either retrieve the teabag with the tea-maker's fingers, which may be messy and dangerous as the hot water can burn, or use a spoon if it is available. When making tea with a stringless teabag or ball-style tea infuser, a spoon is usually required to stir the teabag or tea infuser in the hot water and to remove the teabag or tea infuser from the hot water.

It is common for the tea-maker, after steeping the teabag in the hot water, to squeeze the wet teabag to extract the concentrated tea in the teabag and/or remove the excess liquid from the teabag. The tea-maker can use a spoon to either press the teabag against the inside of the cup or to hold the stringed teabag while winding the string around the teabag and spoon, but these techniques can be awkward, inefficient, and messy.

In order to remove the stringed teabag from the hot water after making tea, the tea-maker must typically displace the wet teabag from the cup of hot water without splashing the hot liquid and potentially burning the tea-maker, avoid spilling the hot liquid castoff by the wet teabag outside the cup of hot water, and find a suitable receptacle to place the wet teabag for reuse or disposal especially when the tea-maker has transported the cup of tea beyond the kitchen and/or out of reach of an appropriate receptacle. Furthermore, when using a spoon to remove a wet teabag or tea infuser from the cup of hot water, the tea-maker encounters the challenge of locating a suitable receptacle for the wet spoon as well as the wet teabag or wet tea infuser.

In such industries as the hospitality, healthcare, and airline industries, guests, patients, and passengers, respectively, can be in a position where they are delivered a teabag and a cup of hot water without also being provided a spoon, swizzle stick, and/or receptacle for the wet teabag. Additionally, for, but not limited to, the reasons cited above, disabled individuals and medical patients with limited functionality can find brewing tea with a teabag or tea infuser a challenge. Therefore, a need exists for improving tea brewing and the handling of wet teabags.

### BRIEF SUMMARY

A tea-making apparatus may include a stem member, a base, and a hanging device. The stem member may include a top end and a bottom end. The base may be attached to the bottom end of the stem member, wherein the base includes a drip pan. The base may include a portion of the base that may contact the tea steeping vessel while the tea-making apparatus may be suspended on the tea steeping vessel. The hanging device attached may be positioned adjacent to top end of the stem member. The hanging device may be adapted to suspend the tea-making apparatus from a rim of a tea steeping vessel.

In some configurations, the tea-making apparatus may include a teabag string catch in close proximity to the stem member top end. The teabag string catch may include a teabag string guide-hook. The teabag string guide-hook may include an inner surface and an outer surface. The inner surface may define a portion of a teabag string-capturing space, the inner surface and the outer surface may come together at an opening into the teabag string-capturing space. The teabag string guide-hook may be configured to guide the teabag string toward the opening. The opening may be configured to allow the teabag string to enter the teabag string-capturing space. The teabag string catch may include a teabag securing device that may be in close proximity to the teabag string-capturing space. The teabag securing device may secure a string of a teabag at a certain position along the string.

A method of making tea may include providing a tea-making apparatus including a stem member, a base, and a hanging device. The stem member may include a top end and a bottom end. The base may be attached to the bottom end of the stem member, wherein the base includes a drip pan. The base may include a portion of the base that may contact the tea steeping vessel while the tea-making apparatus may be suspended on the tea steeping vessel. The hanging device attached may be positioned adjacent to top end of the stem member. The hanging device may be adapted to suspend the tea-making apparatus from a rim of a tea steeping vessel. The method may further include securing a permeable tea leaf container to the tea making apparatus, placing the permeable tea leaf container into a liquid in the steeping vessel, and hanging the tea-making apparatus from the rim of the tea steeping vessel.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced

FIG. 1 is a front elevation view of a tea-making apparatus 100 in accordance with one embodiment.

FIG. 2 is a perspective view of the tea-making apparatus 100 shown in FIG. 1.

FIG. 3 is a perspective view of the tea-making apparatus 100 in FIG. 1 shown in use in association with a tea steeping vessel 200 containing hot water 300.

FIG. 4 is a perspective view from above of the apparatus in FIG. 1 shown in use in association with a tea steeping vessel 200 and a stringed teabag 400, showing the teabag inside the tea steeping vessel and the string of the teabag secured to the apparatus.

FIG. 5 is a right-side perspective view of the apparatus in FIG. 1 shown in use in association with a tea steeping vessel 200 containing hot water 300 and a stringed teabag 400, illustrating lifting a stringed teabag out of the hot water and coupling the stringed teabag with the apparatus.

FIG. 6 is a right-side perspective view of the apparatus in FIG. 1 shown in use in association with a tea steeping vessel 200 containing hot water 300, coupled to a stringed teabag 400, illustrating lifting the coupled apparatus and teabag using the teabag string as a tether such that the wet teabag can drain into the tea steeping vessel.

FIG. 7 is a right-side perspective view of the apparatus in FIG. 1 shown in use in association with a tea steeping vessel 200 containing hot water 300, coupled to a stringed teabag, illustrating lifting the coupled apparatus and teabag above the tea steeping vessel using the teabag string as a tether.

FIG. 8 is a right-side perspective view of the apparatus in FIG. 1 showing the apparatus in use, holding a wet stringed teabag 400, and placed on a dry surface.

FIG. 9 is a right-side perspective view of the apparatus in FIG. 1 shown in use in association with a tea steeping vessel 200 containing hot water 300 and with a tea infuser 600 secured to the apparatus.

FIG. 10 is a right-side perspective view of the apparatus in FIG. 1 shown in use in association with a tea steeping vessel 200 containing hot water 300 and with tea infuser 600.

FIG. 11 is a right-side perspective view of the apparatus in FIG. 1 shown with a stringless teabag 500 secured to the tea-making apparatus 100.

FIG. 12 is a right-side perspective view of the apparatus in FIG. 1 shown in use in association with a tea steeping vessel containing hot water and a stringless teabag secured to the apparatus.

FIG. 13 is a left-side perspective view of the apparatus in FIG. 1 shown in use in association with a tea steeping vessel 200 containing hot water 300 and a stringless teabag 500 secured to the tea-making apparatus 100, illustrating stirring the stringless teabag 500 in the tea steeping vessel 200 containing hot water 300 with the tea-making apparatus 100.

FIG. 14 is a perspective view of the apparatus in FIG. 1 shown in use in association with a tea steeping vessel 200 containing hot water 300 and a stringless teabag 500 secured to the tea-making apparatus 100, illustrating extracting concentrated tea and excess liquid from the stringless teabag with the tea-making apparatus 100.

FIG. 15 is a left-side perspective view of the apparatus in FIG. 1 shown in use in association with a tea steeping vessel 200 containing hot water 300 and a stringless teabag 500 secured to the tea-making apparatus 100, illustrating removing the teabag from the tea steeping vessel 200 containing hot water 300.

FIG. 16 illustrates a set of teabag string catches 1600 in accordance with various embodiments.

FIG. 17 illustrates a set of teabag string catches 1700 in accordance with various embodiments.

FIG. 18 illustrates a set of teabag string catches 1800 in accordance with various embodiments.

FIG. 19 illustrates a set of hanging devices 1900 in accordance with various embodiments.

FIG. 20 illustrates a set of hanging devices 2000 in accordance with various embodiments.

FIG. 21 illustrates a set of hanging devices 2100 in accordance with various embodiments.

FIG. 22 illustrates a set of bases 2200 in accordance with various embodiments.

FIG. 23 illustrates a set of stem members 2300 in accordance with various embodiments.

FIG. 24 illustrates a method 2400 in accordance with one embodiment.

### DETAILED DESCRIPTION

A tea-making apparatus includes a stem member, a base, and a hanging device. The stem member includes a top end and a bottom end. The base may be attached to the bottom end of the stem member, wherein the base includes a drip pan. The base includes a portion of the base that may contact the tea steeping vessel while the tea-making apparatus may be suspended on the tea steeping vessel. The hanging device may be positioned at or attached adjacent to top end of the stem member. The hanging device may be adapted to suspend the tea-making apparatus from a rim of a tea steeping vessel.

In some configurations, the tea-making apparatus includes a teabag string catch in close proximity to the stem member top end. The teabag string catch includes a teabag string guide-hook. The teabag string guide-hook includes an inner surface and an outer surface. The inner surface may define a portion of a teabag string-capturing space, and the inner surface and the outer surface may come together at an opening into the teabag string-capturing space. The teabag string guide-hook may be configured to guide the teabag string toward the opening. The opening may be configured to allow the teabag string to enter the teabag string-capturing space. The teabag string catch may include a teabag securing device that may be positioned in close proximity to the teabag string-capturing space. The teabag securing device may secure a string of a teabag at a certain position along the string.

In some configurations, the teabag string catch may be configured to contact a portion of the teabag when the teabag is lifted by the teabag string, thereby lifting the tea-making apparatus vertically along a side wall of the tea steeping vessel.

In some configurations, the teabag securing device includes at least one of a horizontal wire coil, a horizontal wire hook, a vertical wire pinch, a vertical molded material pinch device, a vertical molded material hook, a vertical wire hook, a horizontal molded material hook, a horizontal molded material pinch, a molded material coil, a wire claw, a molded material claw, and combinations thereof.

In some configurations, the hanging device may be adapted to receive a permeable tea leaf container. The permeable tea leaf container may be a tea infuser or a stringless teabag.

In some configurations, the top end of the stem member includes a handle.

In some configurations, the hanging device includes at least one of a wire hanger, a molded hanger, a cutout tab, and combinations thereof.

In some configurations, the stem includes at least one of, a single wire, multiple parallel wires, multiple wires not parallel to each other, a molded solid material, and combinations thereof.

In some configurations, the drip pan may be dimensioned to capture a liquid dripping from a permeable tea leaf container.

A method of making tea involves utilizing a tea-making apparatus. A tea-making apparatus is provided and includes a stem member, a base, and a hanging device. The stem member has a top end and a bottom end. The base is attached to the bottom end of the stem member, wherein the base includes a drip pan. A portion of the base contacts the tea steeping vessel while the tea-making apparatus is suspended on the tea steeping vessel. The hanging device is located adjacent to the top end of the stem member. The hanging device may be adapted to suspend the tea-making apparatus from a rim of a tea steeping vessel. The method further includes securing a permeable tea leaf container to the tea making apparatus. The method then places a permeable tea leaf container into a liquid in the steeping vessel, followed by hanging the tea-making apparatus from the rim of the tea steeping vessel.

In some configurations, the method further includes vertically lifting the stem member until the permeable tea leaf container is removed from the tea steeping vessel and the permeable tea leaf container is above the drip pan.

In some configurations, the permeable tea leaf container may be a teabag with a teabag string. The teabag string catch on the tea-making apparatus is in close proximity to the stem member top end. The teabag string catch includes a teabag string guide-hook. The teabag string guide-hook includes an inner surface and an outer surface. The inner surface defines a portion of a teabag string-capturing space, the inner surface and the outer surface come together at an opening into the teabag string-capturing space. The teabag string guide-hook may be configured to guide the teabag string toward the opening. The opening is configured to allow the teabag string to enter the teabag string-capturing space. The teabag string catch may include a teabag securing device that is in close proximity to the teabag string-capturing space. The teabag securing device secures the string of the teabag at a certain position along the string.

In some configurations, the method secures the teabag string on the teabag securing device such that the teabag may be suspended in the liquid of the tea steeping vessel. In some instances, vertically lifting the teabag string also vertically lifts the tea-making apparatus. Additionally, after lifting, the drip pan may be above the rim of the tea steeping vessel, the drip pan may be located in a position to capture a dripping liquid from the teabag.

In some configurations, at least one of the base or the stem comprises a flexible material, the method further comprising moving the drip pan toward the stem, wherein the teabag may be located between the drip pan and the stem and liquid may be squeezed from the teabag. In an embodiment, a user squeezes the teabag between the drip pan and the stem.

The tea steeping vessel may be accomplished by a vessel or container with a rim and side wall capable of accepting the tea-making apparatus and capable of receiving a hot liquid to steep a teabag or tea leaf container. The tea steeping vessel may be a drinking vessel such as a cup, glass, mug, etc., designed to hold boiling water, or container boiling water while allowing a user to drink from the contents when the tea is brewed. The tea steeping vessel may be a cooking or heating vessel, such as a pot, pan, teapot, etc., designed to boil water or contain boiling water.

The tea-making apparatus comprises a walled or bowl-shaped base having a stem extending from one side of the base. The stem may include a teabag string catch arranged to hitch onto the stringed teabag. A teabag string-capturing space within the shoulder is adapted to receive the string of the stringed teabag. The teabag string-capturing space is configured on an end with a longitudinal slit in the shoulder, arranged to secure the string of the teabag when making tea. The teabag string-capturing space and the teabag string catch are adapted as a teabag string-guide hook arranged to facilitate coupling the teabag with the device. A sharp single-prong hook extending from the stem adjacent the teabag string catch is arranged to detachably secure the stringless teabag or the tea infuser to the device. Additionally, for example, the single-prong hook is configured to detachably hitch the device to the rim of the cup such that the device is positioned outside the cup. When hitched to the cup with the stringless teabag or tea infuser secured to the single-prong hook, the device is positioned outside of the cup while the stringless teabag or tea infuser is positioned inside the cup such that the stringless teabag or tea infuser can be submerged in hot water for brewing tea.

One of skill in the art will realize that the methods and apparatuses of this disclosure may be configured to accommodate the stringed teabag, stringless teabag, or tea infuser. The methods and apparatuses of this disclosure may be configured to conveniently hook to the rim of the cup making it possible for the tea-maker to transport both the device and the cup wherever the tea-maker carries the cup.

The methods and apparatuses of this disclosure may be configured to secure the string of the stringed teabag to prevent the string and tag of the stringed teabag from being pulled into the hot water when hot water is poured into the cup.

The methods and apparatuses of this disclosure may be configured to provide an apparatus for stirring the stringless teabag and tea infuser in the hot water.

In one embodiment, the apparatuses of this disclosure may be configured to squeeze the wet teabag to extract excess liquid from the wet teabag without the user coming in contact with the liquid, which may be extremely hot.

The methods and apparatuses of this disclosure may be configured to simultaneously capture and contain the hot liquid cast off by the wet teabag or wet tea infuser, the moment the wet teabag or wet tea infuser and tea-making device are lifted above the rim of the cup of hot water, facilitate entirely removing the wet teabag or wet tea infuser from the cup of hot water without splashing or spilling the hot liquid, and provide an autonomous receptacle, suitable for a dry surface, for holding the wet teabag or wet tea infuser outside the cup of hot water such that the wet teabag or wet tea leaves in the tea infuser can be reused or disposed of after use;

The methods and apparatuses of this disclosure may be employed before or after the stringed teabag and hot water are placed in the cup. Once the device is hooked to the cup, the string of the teabag can be drawn through the teabag string-capturing space within the shoulder of the device and pulled along the teabag string-guide hook until the teabag connects with the shoulder. Once coupled, the teabag and the device can be lifted above the rim of the cup which, by force of gravity, automatically orients the base directly underneath the wet teabag for immediately capturing and containing the hot liquid cast off by the wet teabag. The wet teabag, safely contained within the tea-making device, can then be set down on a dry surface without making a mess.

The apparatuses of this disclosure may be a practical, inexpensive, single-apparatus solution, especially in a disposable embodiment, for serving tea in the hospitality, healthcare, and airline industries.

The apparatuses of this disclosure may be an easily operated, single-apparatus solution for making tea with a teabag or tea infuser for disabled individuals and medical patients with limited functionality.

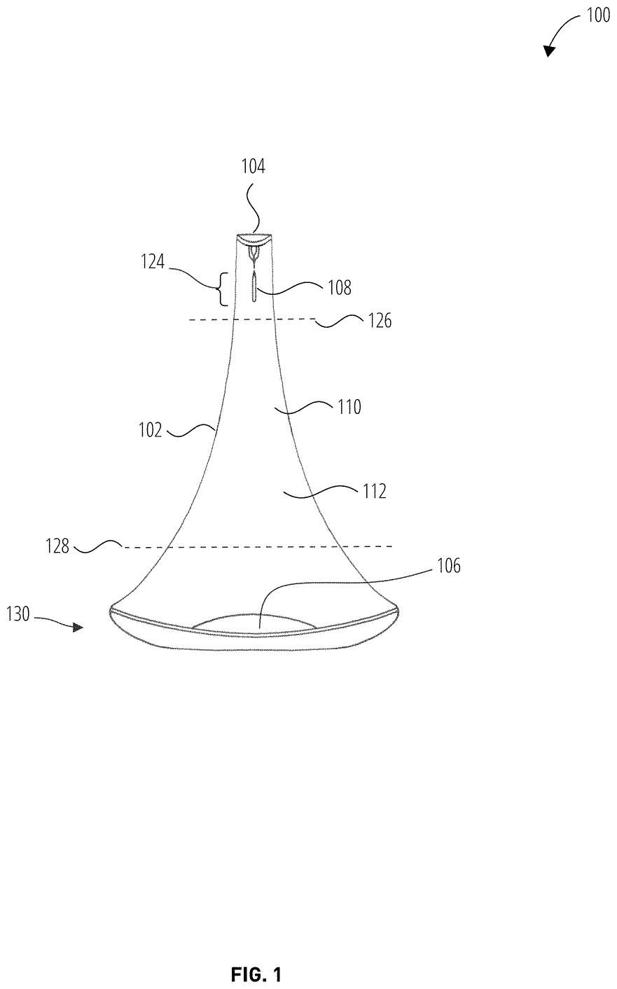

Referencing FIG. 1 through FIG. 8, a tea-making apparatus 100 comprises a stem member 102, a teabag string catch 104, a hanging device 124, and a base 130. The stem member 102 comprises a top end 126, a bottom end 128, a stay 110, and a drip wall 112. The base 130 is coupled adjacent to the bottom end 128 of the stem member 102. The base 130 comprises a drip pan 106 and a portion of the base 136 that may be adapted with an inward-curved lip 122 that conforms to the contours of a tea steeping vessel's side wall. The hanging device 124 is positioned at or adjacent to the top end 126 of the stem member 102 and in close proximity to the teabag string catch 104. The hanging device 124 may comprise a sharp single-prong hook 108 utilized to hold stringless teabags or tea infusers. The teabag string catch 104 may be positioned above the hanging device 124 and may comprise a teabag string-guide hook 120 comprising an inner surface 132 and an outer surface 134. The inner surface 132 defines a teabag string-capturing space 116. The inner surface 132 and the outer surface 134 converge at an opening to teabag string-capturing space 114 that shapes the teabag string-guide hook 120. Within the opening to teabag string-capturing space 114 a teabag securing device 118 is positioned to retain string of a teabag.

FIG. 1 is a front elevation view of the tea-making apparatus 100, showing the tea-making apparatus 100. The Stem member 102, is arranged as a handle for a tea-making apparatus 100 and transitional component to join generally narrower teabag string catch 104 to generally wider drip pan 106. Stem member 102 is comprised of a stay 110, adapted to stabilize the stringed teabag, the stringless teabag or the tea infuser when one or the other is detachably secured to a hanging device 124 configured with a sharp single-prong hook 108, and a drip wall 112, adapted to channel castoff liquid from the wet teabag or the wet tea infuser to the drip pan 106. The drip pan 106, bowl-shaped or having upstanding peripheral walls, is formed to hold the stringed teabag and capture and contain hot liquid cast off by the wet teabag or the wet tea infuser.

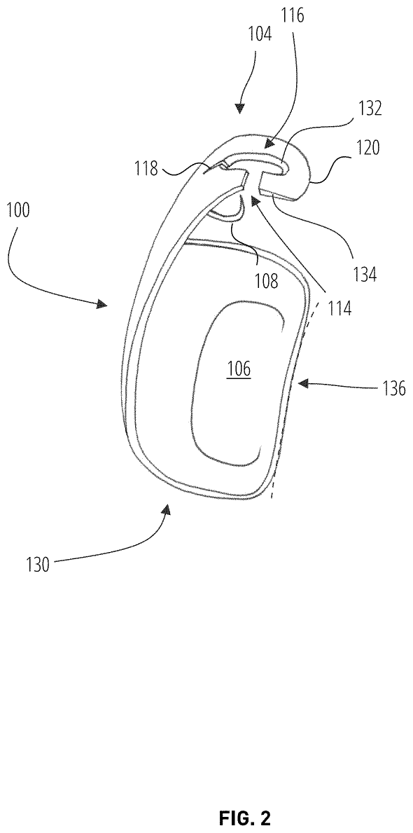

FIG. 2 is a right-side perspective view from above of the tea-making apparatus 100. The teabag string catch 104 includes the opening to teabag string-capturing space 114, the teabag string-capturing space 116, the teabag securing device 118, arranged within the stem, at one end of the teabag string-capturing space 116, to secure the string of the stringed teabag when making tea, and the teabag string-guide hook 120 formed at the distal end of teabag string catch 104, configured to couple the tea-making apparatus 100 with the stringed teabag.

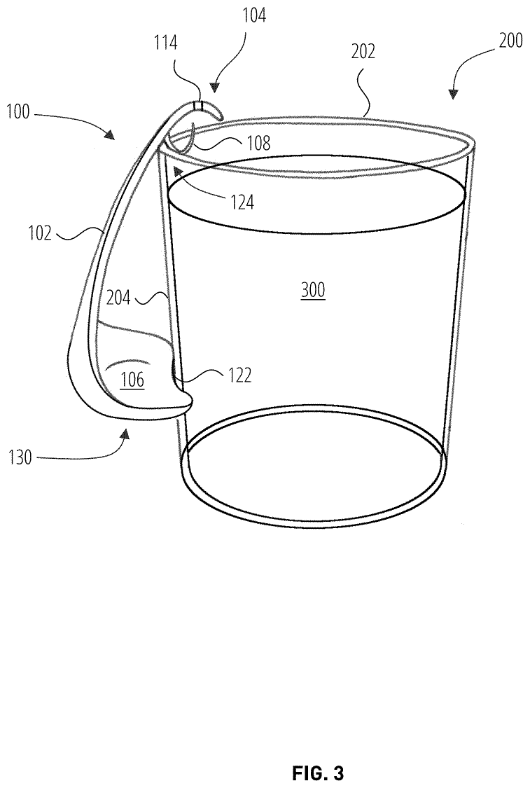

FIG. 3 is a right-side perspective view of the tea-making apparatus 100 shown in use in association with the tea steeping vessel 200 of hot water 300. The sharp single-prong hook 108, arranged on the interior vertex of the stem member 102, is configured to detachably hitch the tea-making apparatus 100 to the rim 202 such that the stem member 102, the teabag string catch 104, and the drip pan 106, are outside of the tea steeping vessel 200. In some configurations, the hanging device 124, seen as sharp single-prong hook 108, may additionally be arranged to position the teabag string catch 104 and the opening to teabag string-capturing space 114 above and away from the rim 202. In some configurations, the hanging device may include a teabag string catch 104 and a teabag string-guide hook 120. In some configurations, the teabag string catch 104 is formed to cover over the sharp single-prong hook 108 and may be adapted as a protective hood for the tip of the sharp single-prong hook 108. The drip pan 106, having an inward-curved lip 122, may be adapted to conform with the convex perimeter of the side wall 204. As the tea-making apparatus 100 may be secured to a variety of cups and other tea brewing vessels, these cups and/or vessels can be transported safely with the tea-making apparatus 100 detachably secured thereto.

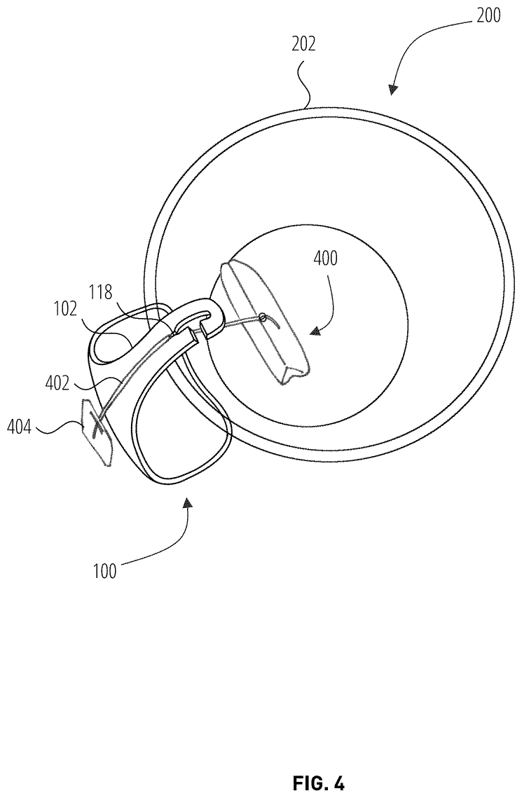

FIG. 4 is a perspective view from above of the tea-making apparatus 100 shown in use in association with the tea steeping vessel 200 and the stringed teabag 400. The tea-making apparatus 100 is detachably hitched to the rim 202. The teabag string 402, attached to the stringed teabag 400, placed inside the tea steeping vessel 200, is detachably secured to the longitudinal slit in the stem member 102 such that the teabag string 402 and the teabag tag 404 are prevented from being pulled into the tea steeping vessel 200 when the hot water is poured into the tea steeping vessel 200 when brewing tea.

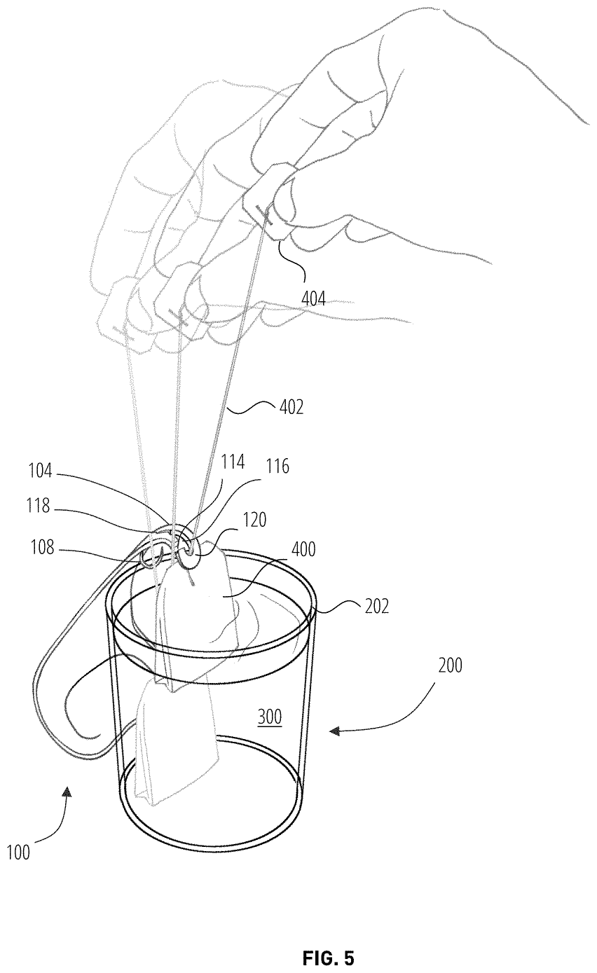

FIG. 5 is a right-side perspective view of the tea-making apparatus 100 shown in use in association with tea steeping vessel 200 of hot water 300 and the stringed teabag 400. the Tea-making apparatus 100 is detachably hitched to the rim 202. The teabag string catch 104 is positioned above and away from the rim 202 by the hanging device 124. Such standoff enables the user to conveniently draw the teabag string 402, attached to the stringed teabag 400, placed inside the tea steeping vessel 200, into the teabag string-capturing space 116 via the opening to teabag string-capturing space 114, as shown. Inside the teabag string-capturing space 116, the teabag string 402 can be secured by the user to the teabag securing device 118, or pulled perpendicularly across the teabag string-guide hook 120 to bring stringed teabag 400 into contact with the teabag string catch 104, and, thereby, couple stringed teabag 400 with the tea-making apparatus 100, as shown.

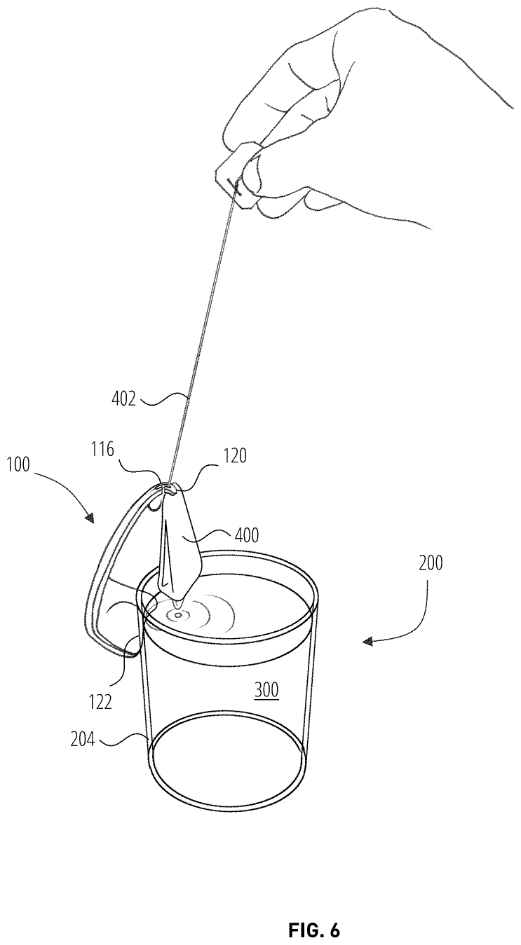

FIG. 6 is a right-side perspective view of the tea-making apparatus 100 shown in use in association with the tea steeping vessel 200 of hot water 300 and the stringed teabag 400. The teabag string 402 can be employed to couple the stringed teabag 400 with the tea-making apparatus 100 and tether the tea-making apparatus 100 to the teabag string 402. Utilizing the teabag string 402 to manipulate the tea-making apparatus 100, the user can lift stringed teabag 400 out of hot water 300 with the tea-making apparatus 100 attached to the stringed teabag 400. Holding the stringed teabag 400 above hot water 300 and positioning the tea-making apparatus 100 such that the tea-making apparatus 100 is retained by the stringed teabag 400 at the teabag string-guide hook 120 and the side wall 204 at the inward-curved lip 122, as shown, the user can allow the wet stringed teabag 400 to drain into the tea steeping vessel 200 before removal.

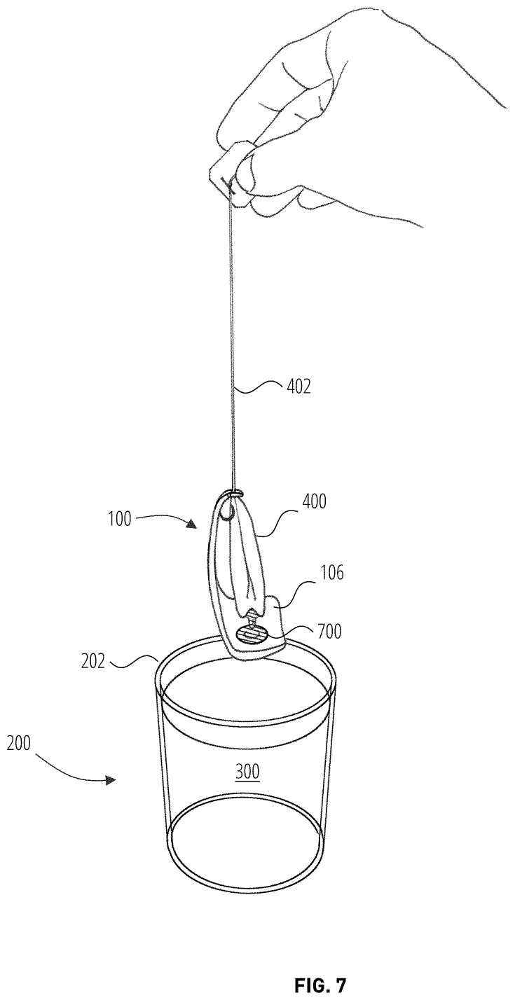

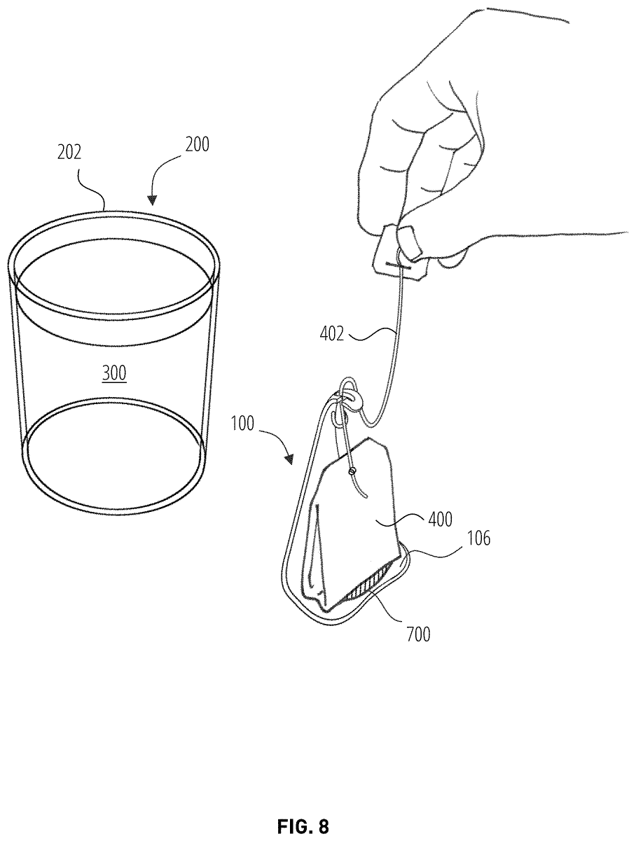

FIG. 7 & FIG. 8 are right-side perspective views of the tea-making apparatus 100 shown in use in association with the tea steeping vessel 200 of hot water 300 and the stringed teabag 400. After the stringed teabag 400 is coupled with and tethered to the tea-making apparatus 100, the user can lift the tea-making apparatus 100 with the teabag string 402 such that the drip pan 106 can clear the rim 202 and automatically reorient directly underneath the wet stringed teabag 400. The drip pan 106 is, thereby, configured to capture and contain the hot castoff liquid 700 from the wet stringed teabag 400 the moment the tea-making apparatus 100 clears the rim 202. Confined to the tea-making apparatus 100 and protected from leaking outside the tea-making apparatus 100, the stringed teabag 400 and the tea-making apparatus 100, can be removed from the tea steeping vessel 200 and placed on a dry surface without making a mess.

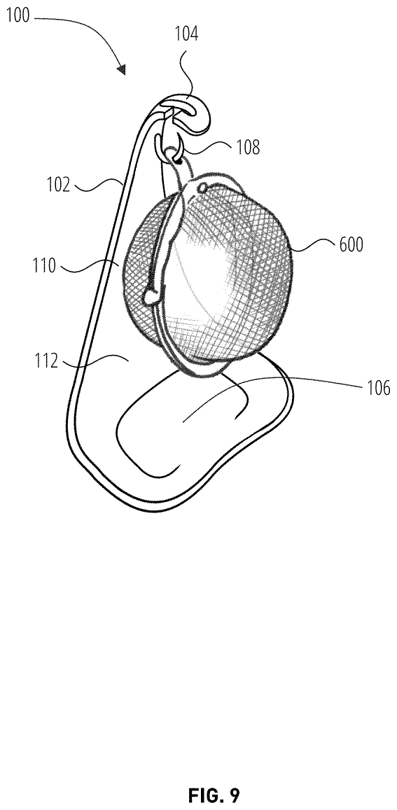

FIG. 9 is a right-side perspective view of the tea-making apparatus 100 shown in association with a tea infuser 600. The sharp single-prong hook 108 is configured such that a tea infuser, such as a tea infuser 600, can be detachably secured to the tea-making apparatus 100, as shown. The stay 110 is adapted to stabilize the secured tea infuser 600 when operating the tea-making apparatus 100. The drip wall 112 is formed to channel hot liquid cast off by the wet tea infuser 600 to the drip pan 106 and protect such liquid from spilling outside the tea-making apparatus 100.

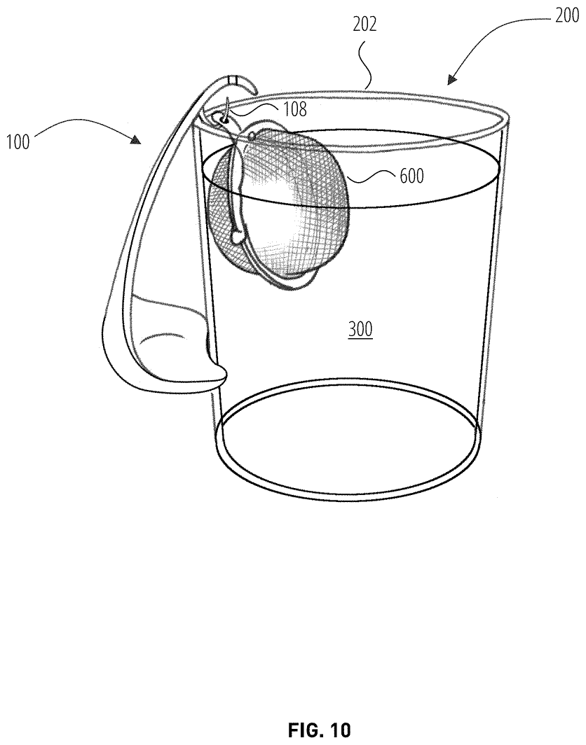

FIG. 10 is a right-side perspective view of the tea-making apparatus 100 shown in use in association with the tea steeping vessel 200 of hot water 300 and tea infuser 600. The tea-making apparatus 100, with the tea infuser 600 detachably secured to the tea-making apparatus 100 via the sharp single-prong hook 108, can be hitched to the rim 202 such that the stem member 102, the teabag string catch 104, and the drip pan 106, are outside of the tea steeping vessel 200 and the tea infuser 600 is submerged in the hot water 300 for brewing tea.

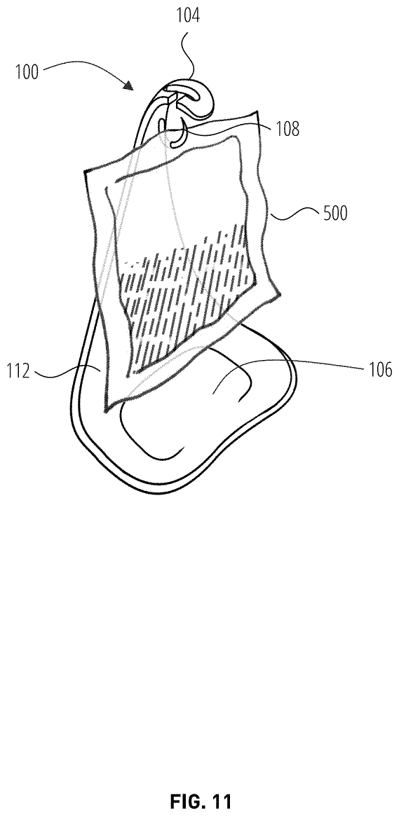

FIG. 11 is a right-side perspective view of the tea-making apparatus 100 shown in association with the stringless teabag 500. The sharp single-prong hook 108 is adapted to easily pierce the stringless teabag 500 and, thereby, detachably secure the stringless teabag 500 to the tea-making apparatus 100. The drip wall 112 is formed to channel the hot castoff liquid 700 cast off by a wet stringless teabag 500 to the drip pan 106 and protect the hot castoff liquid 700 from spilling outside the tea-making apparatus 100.

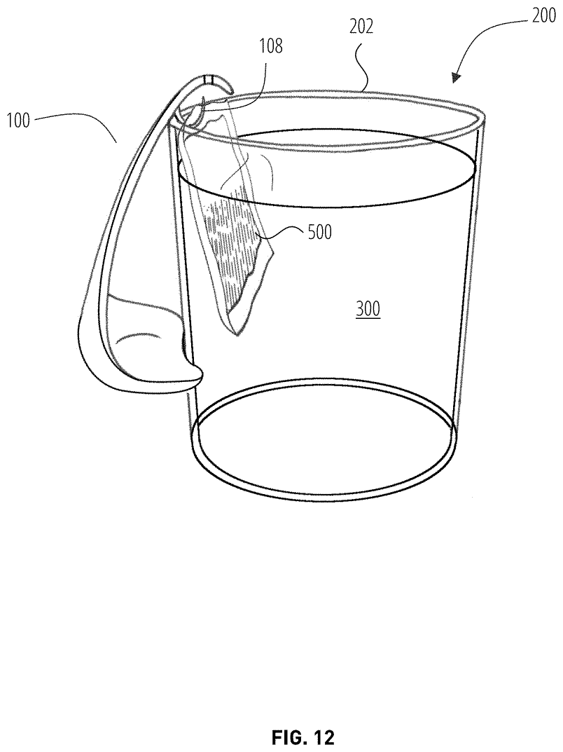

FIG. 12 is a right-side perspective view of the tea-making apparatus 100 shown in use in association with the tea steeping vessel 200 of hot water 300 and the stringless teabag 500. The tea-making apparatus 100, along with the stringless teabag 500, detachably secured to the tea-making apparatus 100 via the sharp single-prong hook 108, can be hitched to the rim 202 of the tea steeping vessel 200 such that the stem member 102, the teabag string catch 104, and the drip pan 106, are outside of the tea steeping vessel 200 and the stringless teabag 500 is submerged in the hot water 300 for brewing tea.

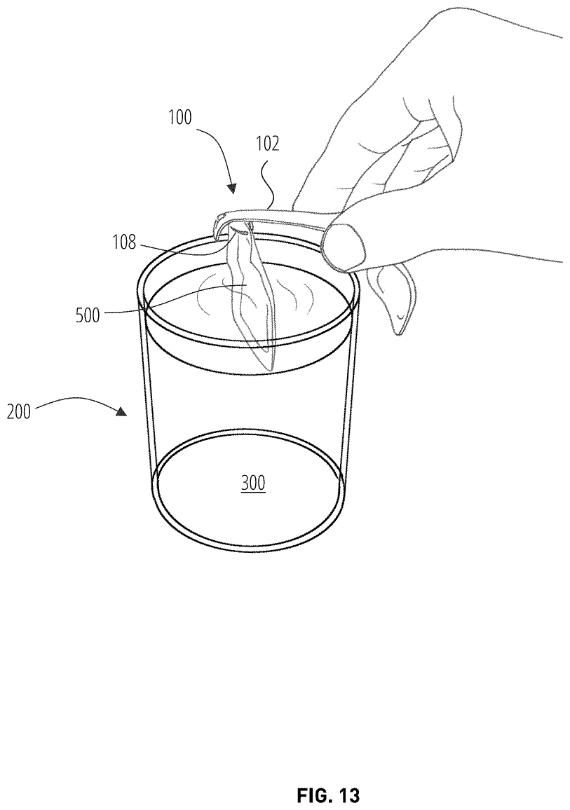

FIG. 13 is a left-side perspective view of the tea-making apparatus 100 shown in use in association with the tea steeping vessel 200 of the hot water 300 and the stringless teabag 500. The stem member 102, configured as a handle for tea-making apparatus 100, can be used to manipulate the tea-making apparatus 100 when brewing tea with the stringless teabag 500 or the tea infuser 600 detachably secured to the sharp single-prong hook 108. For example, the tea-making apparatus 100 can be used to swirl the stringless teabag 500 or the tea infuser 600 in the tea steeping vessel 200 of the hot water 300 to stir the brewing tea, as shown.

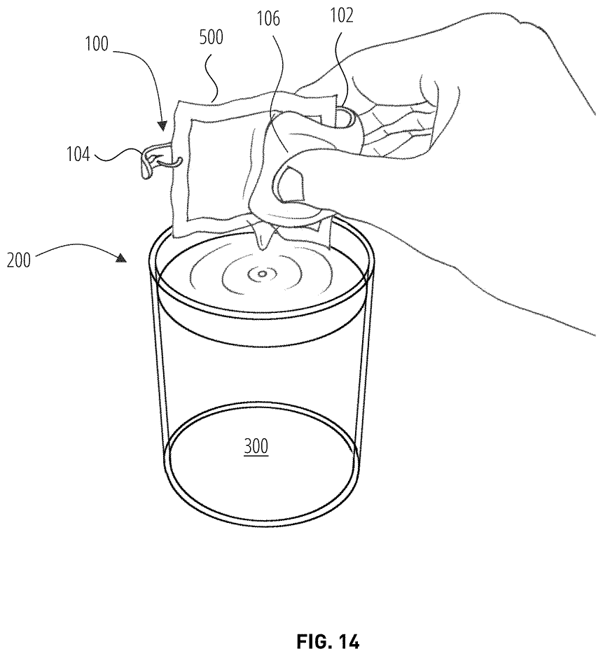

FIG. 14 is a perspective view of the tea-making apparatus 100 shown in use in association with the tea steeping vessel 200 of hot water 300 and the stringless teabag 500. The stem member 102, adapted, in one embodiment made from ridged yet flexible material that can tolerate repeated bending while returning to its original shape without breaking, is arranged to bend and draw the drip pan 106 and the stem member 102 together. This permits the user to squeeze the wet stringless teabag 500 or the wet stringed teabag 400 between the stem member 102 and the drip pan 106 to extract concentrated tea and excess liquid from the wet stringless teabag 500 or the wet stringed teabag 400 without the user coming into contact with hot water 300, as shown. Accordingly, in an example embodiment, a rigid yet elastic material, such as silicone or rubber, is used to construct the stem member 102. In an example embodiment, the drip pan 106 and the teabag string catch 104 are also made from the rigid yet flexible material of the stem member 102, and the stem member 102, the teabag string catch 104, and the drip pan 106, consist of a single piece of ridged yet flexible material.

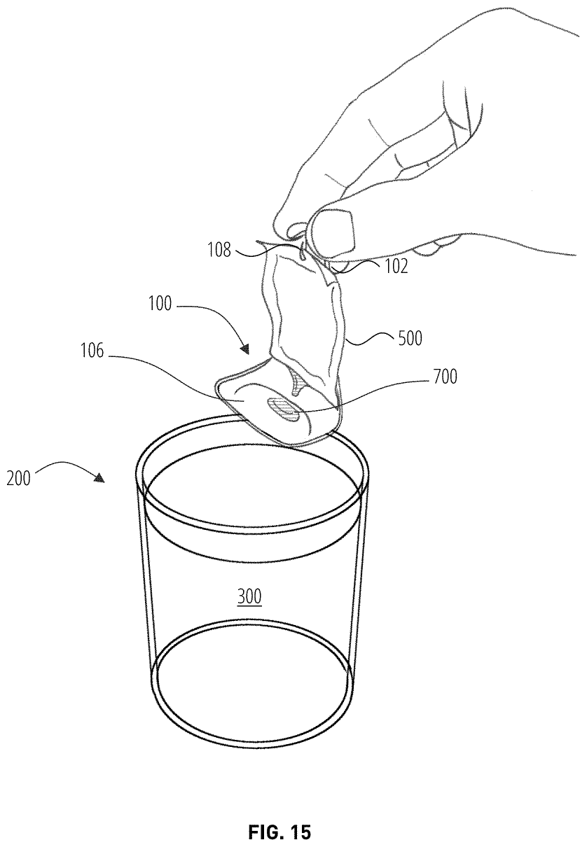

FIG. 15 is a perspective view of the tea-making device 100 shown in use in association with the tea steeping vessel 200 of hot water 300 and the stringless teabag 500. After brewing tea with the stringless teabag 500 or the tea infuser 600 detachably secured to the tea-making apparatus 100, the tea-making apparatus 100 can be manipulated manually to orient base directly underneath the wet stringless teabag 500 or the wet tea infuser 600 to capture and contain the hot castoff liquid 700 while the wet stringless teabag 500 or the wet tea infuser 600 are positioned over the tea steeping vessel 200. Protected from leaking outside the tea-making apparatus 100, the wet stringless teabag 500 or the wet tea infuser 600 and the tea-making apparatus 100 can then be removed from the tea steeping vessel 200 and autonomously placed on a dry surface without making a mess.

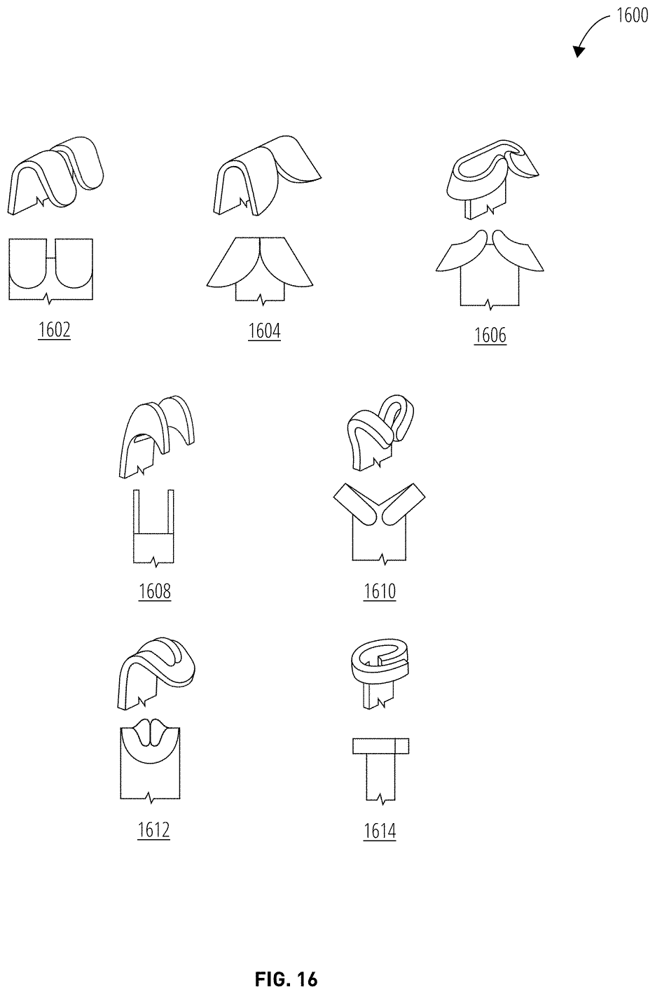

FIG. 16 illustrates a set of teabag string catches 1600 in accordance with various embodiments. The teabag string catches 1600 includes teabag string catch 1602, a teabag string catch 1604, a teabag string catch 1606, a teabag string catch 1608, a teabag string catch 1610, a teabag string catch 1612, and a teabag string catch 1614. The set of teabag string catches 1700 may be extensions of the stem member that are formed to provide the functionality of the teabag string catch.

The teabag string catch 1602 includes two prongs with a downward curve. The two prongs are separated by a gap in middle that may serve as the opening to teabag string-capturing space.

The teabag string catch 1604 includes a curve that bifurcates into two flared bilaterally positioned leaves that taper away from the stem member. The bifurcation of the two leaves may function as the teabag securing device.

The teabag string catch 1606 includes two curved prongs that revolve around a teabag string-capturing space. The prongs are mirrored and meet in the middle where the ends curve up. The two prongs are separated by a slight opening that serves as the opening to teabag string-capturing space.

The teabag string catch 1608 includes two rounded curved claws separated by a gap that may function as the teabag string-capturing space.

The teabag string catch 1610 includes two curved angled prongs that project away from the stem member and curve back towards a point where the two ends of the prongs are separated by a gap. The space between the two curved prongs creates serves as the teabag string capturing space, while the gap between the ends of the two prongs may function as the opening to the teabag string-capturing space.

The teabag string catch 1612 includes a downward curve with a set of guides positioned along the center of the curve. The guides are positioned above the curve and may function as the teabag securing device.

The teabag string catch 1614 extends from the stem with two arms, coiled in a manner where a first arm is curved within the second arm forming the string capturing space. The space formed between the ends of the two arms serves as the opening to the string capturing space.

The teabag string catch 1602, the teabag string catch 1604, the teabag string catch 1606, the teabag string catch 1608, the teabag string catch 1610, the teabag string catch 1612, and the teabag string catch 1614 may be accomplished with materials such as silicone, rubber, plastics, metal, wood, glass, ceramics, and paper.

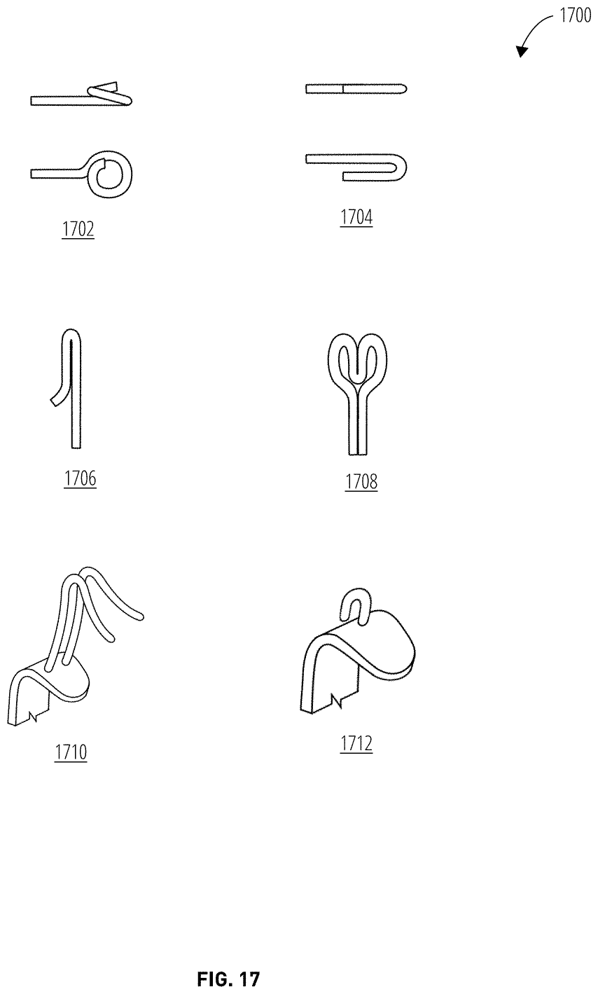

FIG. 17 illustrates a set of teabag string catches 1700 in accordance with various embodiments. The teabag string catches 1700 includes a teabag string catch 1702, a teabag string catch 1704, a teabag string catch 1706, a teabag string catch 1708, a teabag string catch 1710, and a teabag string catch 1712. The teabag string catch 1702, the teabag string catch 1704, the teabag string catch 1708, the teabag string catch 1710, and the teabag string catch 1712 may be integrally coupled to the stem member.

The teabag string catch 1702 is a wire coiled to form a loop that serves as the teabag string-capturing space. The coil includes a gap that serves as the opening to teabag string-capturing space.

The teabag string catch 1704 is a wire bent with a 180 degree curve such that the end of wire runs parallel to the portion of the wire before the bend. The gap between the two portions of the wire may serve as the teabag string-capturing space.

The teabag string catch 1706 is a single wire bent at a 180 degree curve, similar to teabag string catch 1704, with minimal space between the parallel wire segments. The space between the parallel wire segments may function as the teabag string-capturing space. The distal end of the wire curves away from the parallel wire segments that serves to guide a string of a teabag into the teabag string-capturing space and may serve as the opening to teabag string-capturing space.

The teabag string catch 1708 is a curved wire, pinched in the middle forming two curved wire sections. The pinch may serve as the teabag securing device.

The teabag string catch 1702, the teabag string catch 1704, the teabag string catch 1706, and the teabag string catch 1708 may be positioned on a stem member made from a wire construction.

The teabag string catch 1710 includes two wires that extend from a curved portion of the stem member. The curved portion of the stem member may function as the hanging device. The two wires of the teabag string catch 1710 extend away from the stem member and then curve downwardly. The two ends then split forming a gap that tapers towards the curve of the two wires. The tapered gap may serve as the opening to teabag string-capturing space while the space between the two wires may function as the teabag string-capturing space.

The teabag string catch 1712 includes a curved wire similar to the one in the teabag string catch 1704 that form a curved portion of the stem member.

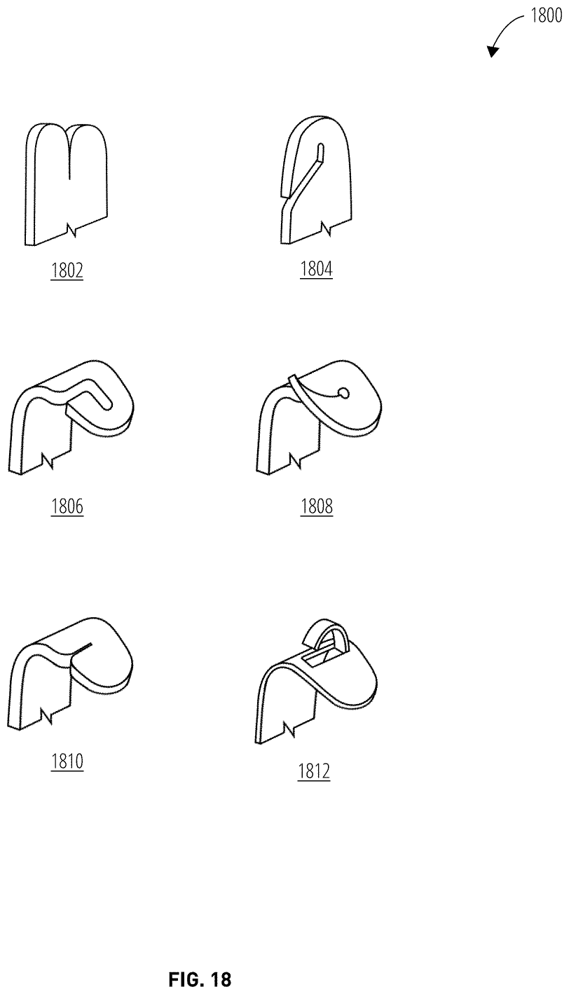

FIG. 18 illustrates a set of teabag string catches 1800 in accordance with various embodiments. The set of teabag string catches 1800 includes teabag string catch 1802, teabag string catch 1804, teabag string catch 1808, teabag string catch 1806, teabag string catch 1810, and teabag string catch 1812. The set of teabag string catches 1800 may be formed sections of the stem member.

The teabag string catch 1802 and the teabag string catch 1804 differ from the other teabag string catches in that the they lack a downward curve. The teabag string catch 1802 and the teabag string catch 1804 extend upwardly from the stem member. The teabag string catch 1802 includes a bifurcation that splits two rounded prongs. The bifurcation between the two rounded prongs may serve as the teabag securing device. The teabag string catch 1804 is formed to include a hook shape with an opening on one side that leads to the teabag string-capturing space.

The teabag string catch 1806, teabag string catch 1808, and the teabag string catch 1810 are curved portions with features for capturing the string. The teabag string catch 1806 forms a teabag string-guide hook with an opening that leads to the teabag string-capturing space. The teabag string catch 1808 includes a hook shape with a rounded lip which serves to guide the teabag string into a teabag string-capturing space. The teabag string catch 1810 includes a laterally positioned slit in the curve that may serve as the teabag securing device.

The teabag string catch 1812 includes a curved portion of the stem member but with a cut out that is bent to form a hook. The curved portion of the hook may serve to form the teabag string-capturing space.

The set of teabag string catches 1800 may be accomplished utilizing materials such as silicone, rubber, plastics, metal, wood, glass, ceramics, and paper. The teabag string catch 1812 may be suitable for construction of a die-cut aluminum.

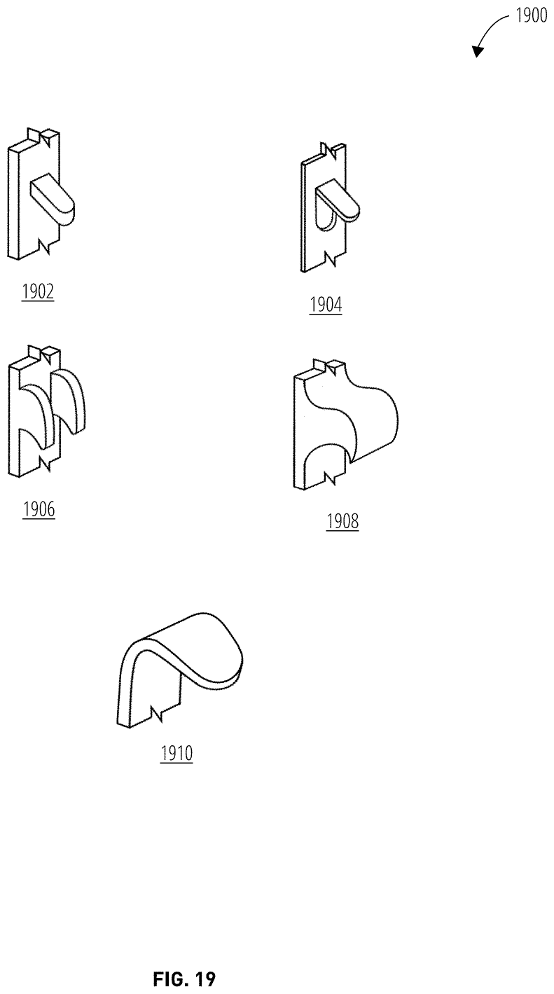

FIG. 19 illustrates a set of hanging devices 1900 in accordance with various embodiments. The set of hanging devices 1900 includes hanging device 1902, hanging device 1904, hanging device 1906, hanging device 1908, and hanging device 1910.

The hanging device 1902 is an extruded tab that extends from the stem member at a downward angle.

The hanging device 1904 is cut out tab that may be bent outwardly from the body of the stem member. The hanging device 1904 may be suited for stem members constructed from materials such as die-cut aluminum or die-cut paper.

The hanging device 1906 is two curved claws that extends from the body of the stem member.

The hanging device 1908 is a single curved claw that extends from the body of the stem member.

The hanging device 1910 is an extension of the stem member with a downward curve. The hanging device 1910 is similar in appearance to the teabag string catch without the feature to capture the teabag string, though in some configurations it may include such feature.

The set of hanging devices 1900 may be accomplished utilizing materials as silicone, rubber, plastics, metal, wood, glass, ceramics, and paper.

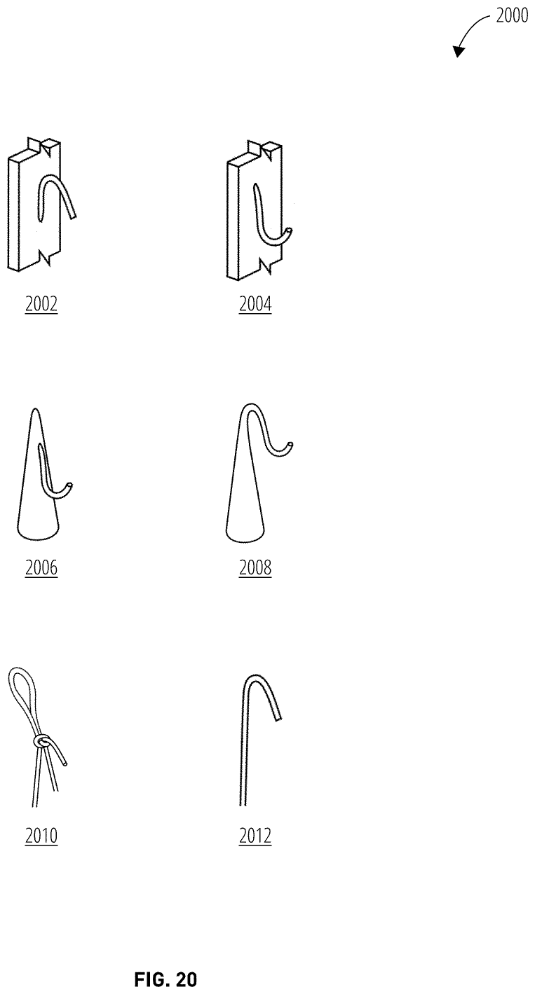

FIG. 20 illustrates a set of hanging devices 2000 in accordance with various embodiments. The set of hanging devices 2000 include hanging device 2002, hanging device 2004, hanging device 2006, hanging device 2008, hanging device 2010, and hanging device 2012. The set of hanging devices 2000 are formed from wire.

The hanging device 2002 and the hanging device 2004 are curved wire pieces that extend from a stem member using materials such as paper, silicone, rubber, plastic, wood, glass, ceramic, and metal. The hanging device 2002 has a downwards curve and the hanging device 2004 has an upward curve.

The hanging device 2006 and the hanging device 2008 are curved wire pieces that may be connected to a stem member constructed out of metal. The hanging device 2006 is a wire piece that extends from the stem member forming the curve. The hanging device 2008 extends from the tip of the stem member and may be formed as one contiguous piece of metal.

The hanging device 2010 and the hanging device 2012 may be curved wire pieces that extend from a wire stem member. The hanging device 2010 may be two wire pieces that form a loop at one end and a single piece of wire extends forming the hanging device 2010. The hanging device 2012 is a curved portion of a single wire stem member.

The hanging device 2004, the hanging device 2006, and the hanging device 2008 may be configured to hold tea infusers.

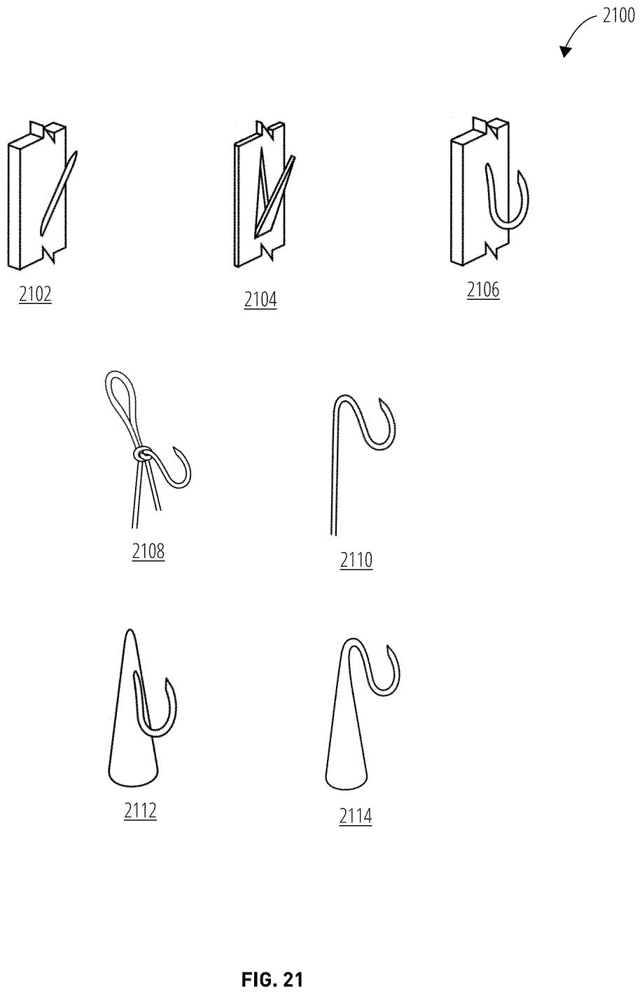

FIG. 21 illustrates a set of hanging devices 2100 that may serve to retain stringless teabags or tea infusers and retaining devices for stringless teabags and tea infusers. The set of hanging devices 2100 includes retaining device 2102, retaining device 2104, hanging device 2106, hanging device 2112, hanging device 2108, hanging device 2110, and hanging device 2114.

The retaining device 2102 is a piece of wire extending from the stem member at an upward angle. The wire of the retaining device 2102 may be sharpened to better engage and hold a stringless tea bag.

The retaining device 2104 is a pointed cut out section of a stem member bent at an upward angle. The point may be sharpened to better engage and hold a stringless teabag. The retaining device 2104 may be suited for stem members constructed from a material such as die-cut aluminum or die-cut paper.

The hanging device 2106 is a curved wire piece extending from the stem member that may function similar to the sharp single-prong hook.

The hanging device 2108 and the hanging device 2110 are formed from a wire stem member. The hanging device 2108 is formed from two parallel running wires that loop at a point. The hanging device 2108 may extend from the position joining the two wire parts of the stem member.

The hanging device 2110 is formed from a stem member using a single wire design. The hanging device 2110 is shaped as a hook.

The hanging device 2112 and the hanging device 2114 are curved wire pieces with a sharp point connected to a stem member constructed out of metal. The hanging device 2112 is a wire pieces that extends from the stem member forming the curve. The hanging device 2114 extends from the tip of the stem member and may be formed as one contiguous piece of metal.

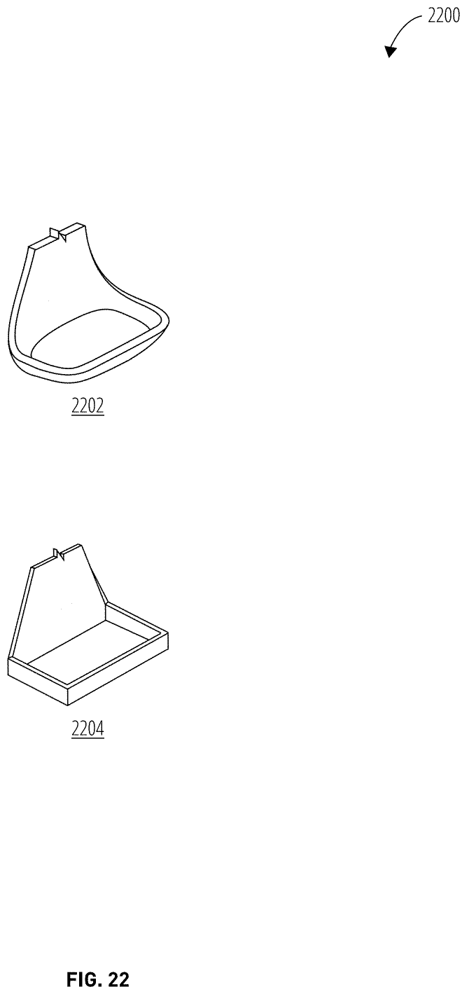

FIG. 22 illustrates a set of bases 2200 in accordance with various embodiments. The set of bases 2200 includes a base 2202 and a base 2204. The base 2202 is a rounded curved based that may be suitable for materials such as silicone, rubber, plastic, wood, metal, glass, and ceramic. The base 2204 is an angular box shaped base that may be suitable for materials such as paper, silicone, rubber, plastic, wood, metal, glass, and ceramic.

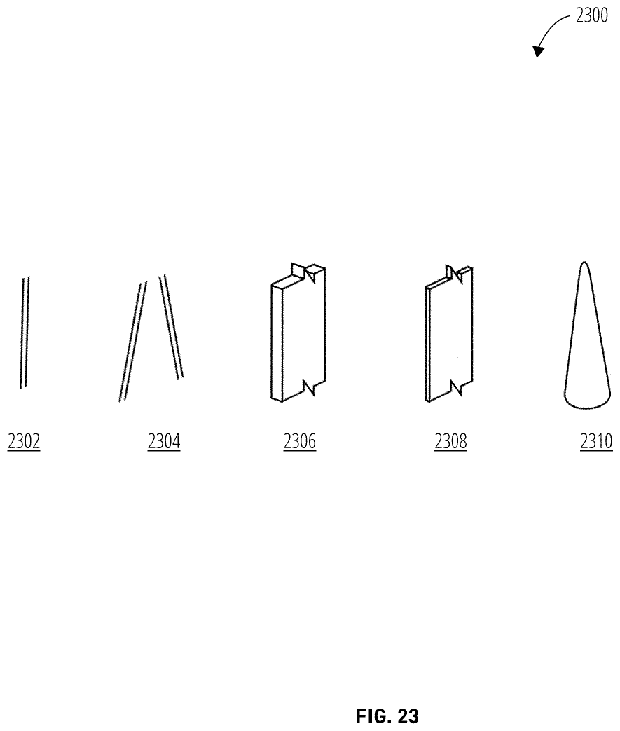

FIG. 23 illustrates a set of stem members 2300 in accordance with various embodiments. The set of stem members 2300 illustrates different construction according to different materials. The stem member 2302 and the stem member 2304 may be configurations of the stem member constructed out of wire.

The stem member 2306 illustrates a stem member with a thickness suitable for construction out of materials such as silicone, rubber, plastic, wood, metal, glass, and ceramic.

The stem member 2308 illustrates a stem member with a thickness suitable for construction out of paper or aluminum.

The stem member 2310 illustrates a stem member suitable for construction out of metal.

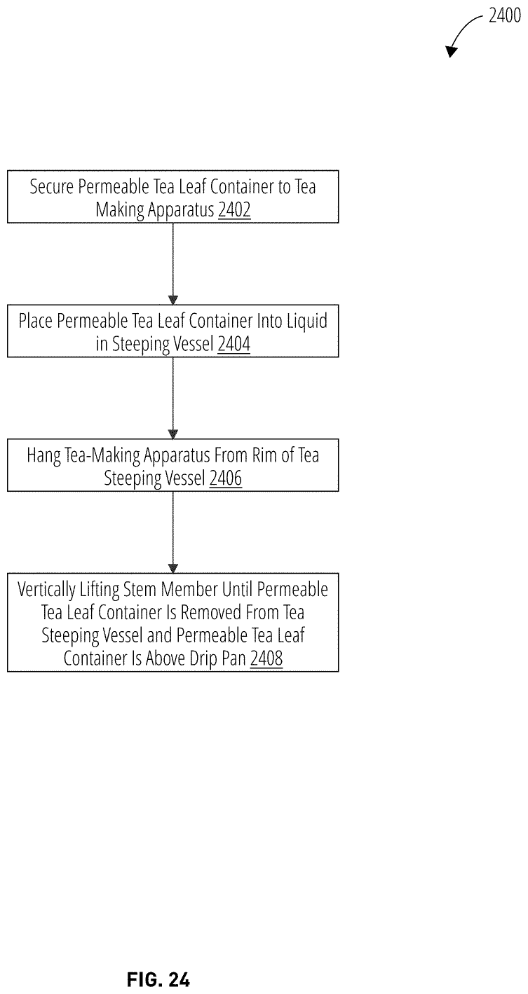

FIG. 24 illustrates a method 2400 of making tea with a tea-making apparatus. The tea-making apparatus comprises a stem member, a base, and a hanging device. The stem member comprises a top end and a bottom end. The base includes a drip pan and is attached to the bottom end of the stem member. The base includes a portion of the base configured to contacts the tea steeping vessel while the tea-making apparatus is suspended on the tea steeping vessel. The hanging device is positioned at or attached adjacent to the top end of the stem member. The hanging device is adapted to suspend the tea-making apparatus from a rim of a tea steeping vessel.

The method 2400 involves securing the permeable tea leaf container to the tea-making apparatus (block 2402). In the block 2404, the method 2400 places a permeable tea leaf container into a liquid in the tea steeping vessel. In the block 2406, the method 2400 hangs the tea-making apparatus from the rim of the tea steeping vessel. In the block 2408, the method 2400 vertically lifts the stem member until the permeable tea leaf container is removed from the tea steeping vessel and the permeable tea leaf container is above the drip pan.

In some configurations, the tea-making apparatus utilized by the method 2400 includes a teabag string catch on the tea-making apparatus positioned at or in close proximity to the stem member top end. The teabag string catch comprises a teabag string guide-hook comprising an inner surface and an outer surface. The inner surface defines a portion of a teabag string-capturing space, the inner surface and the outer surface come together at an opening into the teabag string-capturing space. The teabag string guide-hook may be configured to guide the teabag string toward the opening. The opening may be configured to allow the teabag string to enter the teabag string-capturing space. The teabag string catch may include a teabag securing device that may be in close proximity to the teabag string-capturing space. The teabag securing device may secure the string of the teabag at a certain position along the string.

The method 2400 may utilize the configuration of the tea-making apparatus with the teabag string catch to secure a teabag string on the teabag securing device such that teabag is suspended in liquid of the tea steeping vessel.

In some configurations, the process of vertically lifting the teabag string described in block 2408 may also entail that vertically lifting the teabag string also vertically lifts the tea-making apparatus. Furthermore, after the drip pan is above the rim of the tea steeping vessel, the drip pan is located in a position to capture a dripping liquid from the teabag.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A tea-making apparatus, comprising:
a stem member with a top end and a bottom end;
a base attached to the bottom end of the stem member, wherein the base includes a drip pan; and
a hanging device positioned at or attached adjacent to the top end of the stem member,
wherein the hanging device is adapted to suspend the tea-making apparatus from a rim of a tea steeping vessel, and
wherein a portion of the base contacts the tea steeping vessel while the tea-making apparatus is suspended on the tea steeping vessel.

2. The tea-making apparatus of claim 1, further comprising a teabag string catch positioned at or in close proximity to the top end of the stem member, the teabag string catch comprising:
a teabag string guide-hook, comprising:
an inner surface;
an outer surface,
wherein the inner surface defines a portion of a teabag string-capturing space, the inner surface and the outer surface come together at an opening into the teabag string-capturing space,
wherein the teabag string guide-hook is configured to guide a teabag string toward the opening;
the opening, configured to allow the teabag string to enter the teabag string-capturing space;
a teabag securing device in close proximity to the teabag string-capturing space, wherein the teabag securing device secures the teabag string at a certain position along the teabag string.

3. The tea-making apparatus of claim 2, wherein the teabag string catch is configured to contact a portion of the teabag when the teabag is lifted by the teabag string, thereby lifting the tea-making apparatus vertically along a side wall of the tea steeping vessel.

4. The tea-making apparatus of claim 2, wherein the teabag securing device includes at least one of a horizontal wire coil, a horizontal wire hook, a vertical wire pinch, a vertical molded material pinch device, a vertical molded material hook, a vertical wire hook, a horizontal molded material hook, a horizontal molded material pinch, a molded material coil, a wire claw, a molded material claw, and combinations thereof.

5. The tea-making apparatus of claim 1, wherein the hanging device is adapted to receive a permeable tea leaf container.

6. The tea-making apparatus of claim 5, wherein the permeable tea leaf container is a tea infuser or a stringless teabag.

7. The tea-making apparatus of claim 1, wherein the top end of the stem member comprises a handle.

8. The tea-making apparatus of claim 1, wherein the hanging device comprises at least one of a wire hanger, a molded hanger, a cutout tab, and combinations thereof.

9. The tea-making apparatus of claim 1, wherein the stem comprises at least one of, a single wire, multiple parallel wires, multiple wires not parallel to each other, a molded solid material, and combinations thereof.

10. The tea-making apparatus of claim 1, wherein the drip pan is dimensioned to capture a liquid dripping from a permeable tea leaf container.

11. A method of making tea, the method comprising:
providing a tea-making apparatus, comprising:
a stem member with a top end and a bottom end;
a base attached to the bottom end of the stem member, wherein the base includes a drip pan; and
a hanging device positioned at or attached adjacent to the top end of the stem member,
wherein the hanging device is adapted to suspend the tea-making apparatus from a rim of a tea steeping vessel, and
wherein a portion of the base contacts the tea steeping vessel while the tea-making apparatus is suspended on the tea steeping vessel;
securing a permeable tea leaf container to the tea-making apparatus;
placing the permeable tea leaf container into a liquid in the tea steeping vessel; and
hanging the tea-making apparatus from the rim of the tea steeping vessel.

12. The method of claim 11, further comprising vertically lifting the stem member until the permeable tea leaf container is removed from the tea steeping vessel and the permeable tea leaf container is above the drip pan.

13. The method of claim 12, wherein the top end of the stem member comprises a handle and the stem member is lifted by the handle.

14. The method of claim 12, further comprising capturing a liquid dripping from the permeable tea leaf container, wherein the drip pan is dimensioned to capture at least a portion of the liquid dripping from the permeable tea leaf container.

15. The method of claim 12, wherein the permeable tea leaf container is a tea infuser or a stringless teabag.

16. The method of claim 11, wherein the hanging device comprises at least one of a wire hanger, a molded hanger, a cutout tab, and combinations thereof.

17. The method of claim 11, wherein the permeable tea leaf container is a teabag with a teabag string, the method further comprising:
providing a teabag string catch on the tea-making apparatus positioned at or in close proximity to the stem member top end, the teabag string catch comprising:
a teabag string guide-hook, comprising:
an inner surface;
an outer surface,
wherein the inner surface defines a portion of a teabag string-capturing space, the inner surface and the outer surface come together at an opening into the teabag string-capturing space,
wherein the teabag string guide-hook is configured to guide the teabag string toward the opening;
the opening, configured to allow the teabag string to enter the teabag string-capturing space;
a teabag securing device in close proximity to the teabag string-capturing space, wherein the teabag securing device secures the teabag string at a certain position along the teabag string;
securing the teabag string on the teabag securing device such that the teabag is suspended in the liquid of the tea steeping vessel.

18. The method of claim 17, further comprising vertically lifting the teabag string until the teabag has been removed from the tea steeping vessel,
wherein vertically lifting the teabag string also vertically lifts the tea-making apparatus,
wherein after the drip pan is above the rim of the tea steeping vessel, the drip pan is located in a position to capture a dripping liquid from the teabag.

19. The method of claim 18, further comprising moving the drip pan toward the stem, wherein the teabag is located between the drip pan and the stem, and liquid is squeezed from the teabag, wherein at least one of the base or the stem comprises a flexible material.

20. The method of claim 17, wherein the teabag securing device includes at least one of a horizontal wire coil, a horizontal wire hook, a vertical wire pinch, a vertical molded material pinch device, a vertical molded material hook, a vertical wire hook, a horizontal molded material hook, a horizontal molded material pinch, a molded material coil, a wire claw, a molded material claw, and combinations thereof.
